(19) United States
(12) Patent Application Publication
(10) Pub. No.: US 2020/0256269 A1
(43) Pub. Date: Aug. 13, 2020

(54) ECM STARTER ASSEMBLY FOR ELECTRONICALLY CONTROLLED ENGINE

(71) Applicant: Paulus Johannes AUCAMP, Middelburg, Mpumalanga (ZA)

(72) Inventor: Paulus Johannes AUCAMP, Middelburg, Mpumalanga (ZA)

(21) Appl. No.: 15/781,544

(22) PCT Filed: Dec. 7, 2016
(86) PCT No.: PCT/IB2016/057405

§ 371 Date: Jun. 5, 2018

(30) Foreign Application Priority Data
Dec. 10, 2015 (ZA) 2015/08999

(51) Int. Cl. F02D 41/06; F02D 41/38; B60K 15/03; F02M 59/42; F02N 7/00; F02B 63/04; F02M 55/02; F02N 19/00; F02M 59/10

(52) U.S. Cl. CPC F02D 41/062; F02D 41/38; B60K 15/03; F02M 59/42; F02N 7/00; B60K 2015/03243; F02M 55/025; F02N 19/00; F02M 59/105; F02M 59/107; F02B 63/042

(57) ABSTRACT

This invention relates to a starter system for an electronically controlled internal combustion engine which is particularly, although not exclusively, suitable for use on electronically controlled diesel engines used in trackless mining machinery. The starter system adapted to actuate an electronic engine control module (ECM) of an electronically controlled fuel-injection engine when the engine is started, wherein the engine comprises a fuel tank and a high pressure injector pump which are arranged in flow communication with a series of injector nozzles. The starter system is characterised therein that it comprises an alternator which is operatively associated with the ECM for actuating the ECM, the arrangement being such that when the engine is started, the alternator supplies the ECM with electrical current before the engine is cranked.

### INTRODUCTION

This invention relates to a starter system for an electronically controlled internal combustion engine. Particularly, although not exclusively, the starter system is used on electronically controlled diesel engines used in trackless mining machinery.

### BACKGROUND TO THE INVENTION

Those who are engaged in the mining industry will appreciate that equipment used in mining operations must comply with legislatively controlled standards and requirements. This is particularly so in underground mining operations, such as platinum, gold, diamond and coal mines, where explosive and/or otherwise flammable gasses and/or mining surfaces are frequently encountered.

A diesel engine (also known as a compression-ignition engine) is an internal combustion engine in which ignition of fuel that has been injected into the combustion chamber is initiated by the high temperature which a gas achieves when greatly compressed (adiabatic compression). Diesel exhaust is the gaseous exhaust produced by a diesel type of internal combustion engine. The physical and chemical conditions that exist inside any diesel engine under any conditions differ considerably from spark-ignition engines, because, by design, diesel engine power is not controlled by an air/fuel mixture (as in most gasoline engines), but rather it is directly controlled by the fuel supply. However, the lean-burning nature of diesel engines and the high temperatures and pressures of the combustion process result in significant production of gaseous nitrogen oxides (NO_{X}), an air pollutant, which constitutes a unique challenge with regard to its reduction.

Moreover, fine particulate matter in diesel exhaust (sometimes visible as opaque dark-coloured smoke) has traditionally been of greater concern, as it presents different health concerns. Diesel particulate matter (“DPM”), sometimes also called diesel exhaust particles (“DEP”), is the particulate component of diesel exhaust, which includes diesel soot and aerosols, such as ash particulates, metallic abrasion particles, sulphates and silicates. When released into the atmosphere, DPM can take the form of individual particles or chain aggregates, with most in the invisible sub-micrometre range of 100 nanometre. Diesel exhaust contaminants also include substances listed as human carcinogens by the World Health Organisation. Because of their small size, inhaled particles may easily penetrate deep into the lungs. The rough surfaces of these particles make it easy for them to bind with other toxins in the environment, thus increasing the hazards of particle inhalation.

Diesel engines are categorised according to a global European Emission Standard (“EMS”), which define the acceptable limits for exhaust emissions and which measures, inter alia, DPM emissions from engines. European standards for non-road diesel engines harmonize with the US EPA standards and comprise gradually stringent tiers known as Tier 1-4 standards. So, for example, Tier 0-Tier 2 engines are fuel-injection engines wherein the air/fuel mixture, ignition timing and idle speed are mechanically set and dynamically controlled by mechanical and pneumatic means. Tier 0 and Tier 1 engines are naturally aspirated (under atmospheric pressure), while Tier 2 engines are turbo charged. All of Tier 0-Tier 2 engines comprise a fuel injector pump for feeding individual unit injectors (or pump nozzles) with diesel fuel. Until recently, diesel engines in underground mining operations were required to meet Tier 2 standards of emission. However, because of the levels of DPM still emitted by Tier 2 engines and the resultant conflict with increasingly stringent legislative health and safety regulations, emission requirements are heading towards a Tier 3 standard of emission, also in respect of diesel engines used in mining applications.

The only way to achieve Tier 3 standards of emission in diesel engines is to move away from conventional mechanically controlled engines to electronically controlled engines. Electronically controlled engines comprise an electronic engine control module (ECM) that controls a series of actuators on an internal combustion engine to ensure optimal engine performance. It does this by reading values from a multitude of sensors within an engine bay, interpreting the data using multidimensional performance maps and adjusting the engine actuators accordingly.

Tier 3 electronically controlled engines comprise common rail direct fuel injection, with an injector pump supplying pressure to all injectors, and with the ECM controlling injection timing and duration. On diesel engines common rail direct fuel injection features a high-pressure (over 100 MPa) fuel rail feeding individual solenoid valves. The primary factor used in determining the amount of fuel required by the engine is the amount (by weight) of air that is being taken in by the engine for use in combustion. Modern systems use a mass airflow sensor to send this information to the ECM. The result is reduced fuel wastage consequential to optimal combustion.

Electronically controlled engines (in flameproof environments) are typically started with either a hydraulically or pneumatically actuated starter motor. In particular, either hydraulic or pneumatic pressure is stored in an accumulator and released as available energy to crank the engine. A Tier 3 engine also includes a battery which is connected to and encased with the ECM in a flame-proof enclosure. During the engine starting process, the battery first supplies electrical power to the ECM, which in turn monitors the engine sensors and controls fuel supply to the injectors. The engine is cranked using the stored hydraulic or pneumatic pressure. When signalled by the ECM, the fuel injector pump opens and sprays pressurised fuel directly from the fuel tank through the injector nozzles into the engine. The duration that the injector pump is open (called the pulse width) is proportional to the amount of fuel delivered. Upon combustion of the fuel, the engine starts turning.

Battery actuation of the ECM suffers from a number of disadvantages. Batteries in themselves generate explosive gasses, which are highly problematic in mining applications, particularly underground mining applications. Moreover, batteries require intermittent replacement, which increases costs and inconvenience, particularly if a battery runs flat while an engine is used underground. If that happens, the engine is completely in-operational and needs to be towed to a safe area where the batteries can be replaced, often resulting in unwanted downtime and associated losses, as well as logistical challenges associated with towing the often large machines in which such engines are typically housed.

Another disadvantage associated with Tier 3 engines is a time delay between when an engine is started (cranked) and when the engine starts running. This time delay depends, inter alia, on the distance between the fuel tank and an engine combustion chamber, as well as vertical positioning of the fuel tank relative to the combustion chamber, as the injector pump is required to draw fuel from the fuel tank to the injector nozzles before combustion can occur and the engine can start running. The fuel tank typically may be located approximately 500 mm to 2000 mm from the injectors, resulting in a time delay of as much as 7 seconds from when the ECM is actuated until the moment of combustion. This time delay is also influenced by factors such as diameter of common rail pipes and blockages in the fuel system. As a result of these factors fuel pressure in the common rail may adversely be influenced, resulting in the frustrating time delay associated with engine start-up.

It is accordingly an object of the invention to provide a modified starter system for an electronically controlled fuel-injection engine that will do away with the ECM battery, and which will achieve substantially immediate actuation of the engine upon initialisation of the ECM.

### SUMMARY OF THE INVENTION

According to the invention there is provided a starter system adapted to actuate an electronic engine control module (ECM) of an electronically controlled fuel-injection engine when the engine is started, wherein the engine comprises a fuel tank and a high pressure injector pump which are arranged in flow communication with a series of injector nozzles; the starter system comprising an alternator which is operatively associated with the ECM for actuating the ECM, the arrangement being such that when the engine is started, the alternator supplies the ECM with electrical current before the engine is cranked.

The alternator may be a hydraulic or pneumatic pressure driven alternator. In one embodiment of the invention, the alternator may operatively be associated with hydraulic or pneumatic actuators of the engine. In an alternative embodiment of the invention, the starter system may include secondary hydraulic or pneumatic actuators which are operatively associated with the alternator such that the secondary hydraulic or pneumatic actuators actuate only the alternator. The alternator is actuated through a release valve, which releases hydraulic or pneumatic energy from an accumulator to a hydraulic or pneumatic pressure driven alternator driver motor, which driver motor in turn is mechanically linked to the alternator for supplying the alternator with mechanical energy. This enables the alternator to generate electrical current supply to the ECM for actuating the ECM.

The ECM alternator may be disconnected from the engine such that the ECM alternator is actuated first and before the engine starts running.

The starter system also may include a secondary low pressure primer pump which is arranged in flow communication with the fuel tank and the injector pump, the primer pump being adapted to maintain a positive fuel pressure at the injector pump at commencement of an engine starting process, thus enabling substantially immediate starting of the engine. It will be appreciated by skilled artisans that optimal suction performance of fuel injector pumps is only achieved at higher RPM's (Revolutions Per Minute), typically in the range of above 500 RPM. The result of such delayed performance of the fuel injector pump is insufficient pressure supply to the high pressure fuel injector pump upon cranking of the engine. Introduction of the primer pump overcomes this disadvantage by supplying increased fuel supply to the fuel injector pump before or while the engine is being cranked, thus reducing starting time.

The primer pump may be positioned intermediate the fuel tank and the injector pump such that fuel from the fuel tank passes through the primer pump before proceeding to the injector pump, the arrangement being such that a constant fuel pressure is maintained at the injector pump. Consequently, much less actuation energy is required for cranking the engine due to reduced cranking times. For example, in the absence of a primer pump, an electronically controlled engine would require a cranking time of between 7 and 14 seconds. The required energy source (e.g. hydraulic or pneumatic pressure fluids) is significant and would typically be in the order of about 200 litres at a 10 bar pressure. A further consequence of such long cranking times is the increased production of toxic diesel particulate material and NO_{X}, which can have serious health consequences in enclosed spaces such as underground mining environments. By contrast, by introducing a primer pump, the cranking time for the same engine can be reduced to between 2 and 4 seconds, while the energy source can be reduced to as low as 40 litres at 10 bar pressure.

In one embodiment of the invention, the primer pump may be linked mechanically to the alternator driver motor such that when the alternator driver motor is actuated by the hydraulic or pneumatic pressure, the driver motor not only actuates the alternator, but also actuates the primer pump. The primer pump then draws fuel from the fuel tank and provides priming pressure to the injector pump either before the engine is cranked, or simultaneously while the engine is being cranked.

In an alternative embodiment of the invention, the primer pump may operatively be associated with a second, independent actuator which is actuated by the hydraulic or pneumatic pressure, the arrangement being such that upon actuation of the primer pump, the primer pump draws fuel from the fuel tank and provides priming pressure to the injector pump either before the engine is cranked, or simultaneously while the engine is being cranked. In particular, the primer pump may be a hydraulic or pneumatic pressure actuated primer pump.

In one embodiment of the invention, the primer pump may operatively be associated with hydraulic or pneumatic actuators of the engine.

In an alternative embodiment of the invention, the starter system may include secondary hydraulic or pneumatic actuators which are operatively associated with the primer pump such that the secondary hydraulic or pneumatic actuators actuate the primer pump and an alternator driver motor.

The primer pump is actuated through a release valve, which releases hydraulic or pneumatic energy from an accumulator to the hydraulic or pneumatic pressure driven alternator driver motor, which driver motor in turn is mechanically linked to the primer pump for supplying the primer pump with mechanical energy. This enables the primer pump to provide priming fuel pressure to the high pressure injector pump.

The starter system also may include a timer sequence unit which manages time delay between actuation of the alternator and ECM, fuel supply to the engine, and cranking of the engine thus ensuring that sufficient electricity and fuel is supplied to the engine, before the engine is cranked or while the engine is being cranked. The sequence unit is operatively associated with the hydraulic or pneumatic actuators, the alternator and an engine starter motor.

The starter system is particularly suitable for use on electronically controlled fuel-injection diesel engines used in trackless mining machinery.

According to a second aspect of the invention there is provided an electronically controlled fuel-injection engine comprising an ECM and a starter system for actuating the ECM, the starter system comprising an alternator which is operatively associated with the ECM for actuating the ECM such that when the engine is started, the alternator supplies the ECM with electrical current either before the engine is cranked, or while the engine is being cranked. The alternator may be a hydraulic or pneumatic pressure driven alternator.

According to a third aspect of the invention there is provided a method of actuating an ECM of an electronically controlled fuel-injection engine, the method comprising the use of an alternator which is operatively associated with the ECM for actuating the ECM such that when the engine is started, the alternator supplies the ECM with electrical current before the engine is cranked or while the engine is being cranked. The alternator may be a hydraulic or pneumatic pressure driven alternator.

The method may include the additional steps of providing hydraulic or pneumatic actuators which are positioned such that they actuate only the alternator and which include a release valve; and a hydraulic or pneumatic pressure driven alternator driver motor which is operatively associated with the hydraulic or pneumatic actuators and with the alternator; the arrangement being such that by releasing the release valve, hydraulic or pneumatic energy is released to the alternator driver motor, which in turn supplies the alternator with energy such that the alternator generates electrical current supply to the ECM for actuating the ECM.

In an alternative embodiment of the invention, the method may include the additional steps of providing hydraulic or pneumatic actuators which are positioned such that they actuate both the alternator and the primer pump, either simultaneously or sequentially, the arrangement being such that the primer pump may selectively be disengaged once the common rail system can sustain its own low pressure fuel supply.

### SPECIFIC EMBODIMENT OF THE INVENTION

The invention will now further be described by way of non-limiting example only and with reference to the accompanying drawings in which

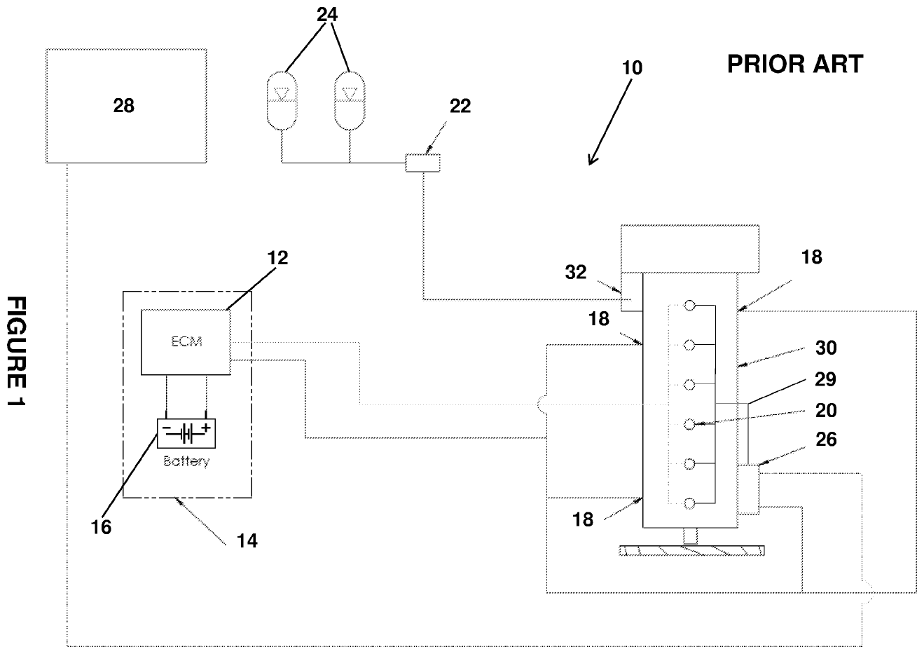

FIG. 1 is a schematic diagram of a prior art electronically controlled fuel injection engine, illustrating the battery and ECM assembly in a flame proof enclosure;

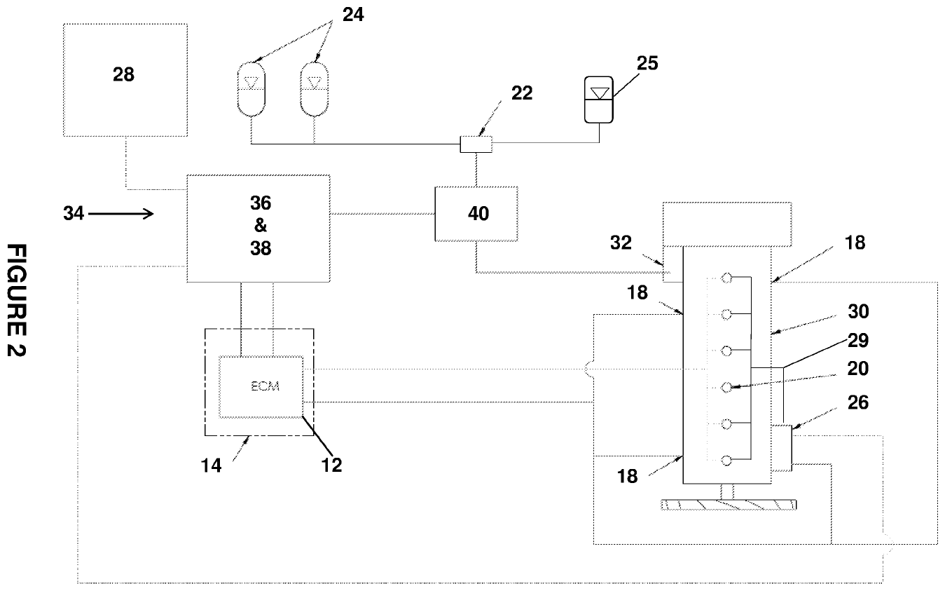

FIG. 2 is a schematic diagram of an electronically controlled fuel injection engine according to one embodiment of the invention comprising a starter system according to the invention, including an alternator and primer pump, wherein the primer pump is mechanically linked to the alternator driver motor;

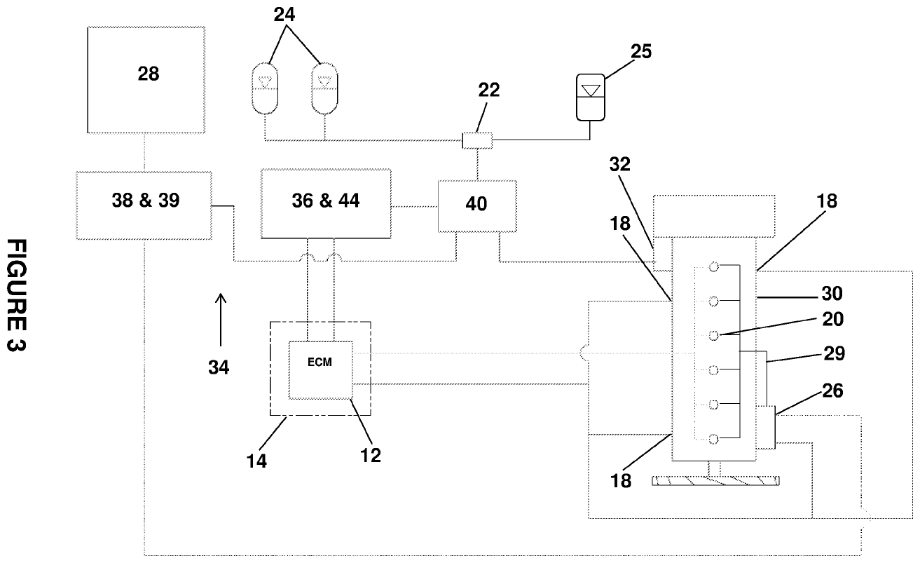

FIG. 3 is a schematic diagram of an electronically controlled fuel injection engine according to a second embodiment of the invention, wherein the primer pump is operatively associated with a second, independent driver which is actuated by hydraulic or pneumatic pressure; and

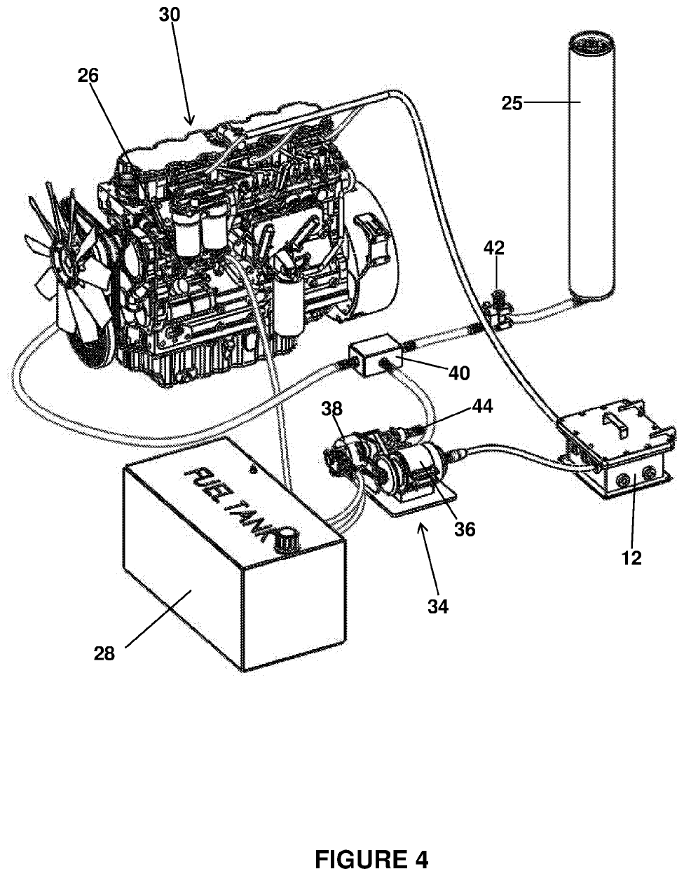

FIG. 4 is a three dimensional illustration of an electronically controlled fuel injection engine according to the first embodiment of the invention.

In prior art electronically controlled engines [10] (FIG. 1), an electronic engine control module (ECM) [12] is encased in a flameproof enclosure [14], together with a battery [16]. During an engine [30] starting process, the battery [16] first supplies electrical power to the ECM [12], which in turn monitors a series of engine sensors [18] and controls fuel supply to a series of injector nozzles [20]. The engine is typically started with either a hydraulically or pneumatically actuated starter valve [22], which releases hydraulic or pneumatic pressure stored in (an) accumulator(s) [24] as available energy to a starter motor [32] to crank the engine [30]. When signalled by the ECM [12], a fuel injector pump [26] opens and sprays pressurised fuel directly from a fuel tank [28] through the injector nozzles [20] into the engine [30]. The fuel tank [28] is directly linked to the injector pump [26], which in turn is directly linked to a high pressure common rail fuel line [29]. Injector nozzles are connected to the high pressure common rail fuel line [29].

The invention as illustrated in FIGS. 2 and 4 provides a novel starter system [34] which is adapted to actuate the ECM [12] of an electronically controlled fuel-injection engine [30] when the engine is started. The engine [30] comprises a fuel tank [28] and a high pressure injector pump [26] which are arranged in flow communication with a series of injector nozzles [20]. The starter system [34] is characterised therein that it comprises an alternator [36] which is operatively associated with the ECM [12] for actuating the ECM [12], the arrangement being such that when the engine [30] is started, the alternator [36] supplies the ECM [12] with electrical current before and while the engine [30] is cranked.

The alternator [36] may be anyone of a hydraulic or pneumatic pressure driven alternator [36]. In one embodiment of the invention the alternator [36] is associated with the hydraulic or pneumatic actuators [24] of the engine [30]. In an alternative embodiment of the invention, the alternator [36] is operatively associated with secondary hydraulic or pneumatic actuators [25] which are positioned to actuate only the alternator [36].

With reference to the embodiment of the invention illustrated in FIG. 4, the alternator [36] is actuated by a hydraulic or pneumatic release valve [42] (the release valve is indicated by reference numeral [22] in FIGS. 1 to 3), which releases hydraulic or pneumatic energy from (an) accumulator(s) [25] to a hydraulic or pneumatic pressure driven alternator driver motor [44]. The driver motor [44] is mechanically linked to the alternator [36] for supplying the alternator [36] with mechanical energy. This enables the alternator [36] to generate electrical current supply to the ECM [12] for actuating the ECM [12].

The ECM alternator [36] is disconnected from the engine [30] such that the alternator [36] is actuated first and before the engine [30] starts running.

In the illustrated embodiments the starter system [34] also includes a secondary low pressure primer pump [38] which is arranged in flow communication with the fuel tank [28] and the injector pump [26]. The primer pump [38] is positioned intermediate the fuel tank [28] and the injector pump [26] such that fuel from the fuel tank [28] passes through the primer pump [38] before proceeding to the injector pump [26]. The primer pump [38] is adapted to maintain a positive fuel pressure at the injector pump [26] at commencement of an engine [30] starting process, thus enabling substantially immediate starting of the engine [30].

In the embodiments of FIGS. 2 and 4, the primer pump [38] is mechanically linked to the alternator driver motor [44] such that when the alternator driver motor [44] is actuated by the hydraulic or pneumatic pressure, it not only actuates the alternator [36], but also actuates the primer pump [38]. The primer pump [38] then draws fuel from the fuel tank [28] and provides positive fuel pressure to the injector pump [26] even before the engine [30] is cranked, or simultaneously while the engine [30] is being cranked.

In the embodiment of FIG. 3, the primer pump [38] is operatively associated with a second, independent actuator [39] which is actuated by hydraulic or pneumatic pressure, the arrangement being such that upon actuation of the primer pump [38], the primer pump [38] draws fuel from the fuel tank [28] and provides priming pressure to the injector pump [26] either before the engine [30] is cranked, or simultaneously while the engine [30] is being cranked. In particular, the primer pump [38] is a hydraulic or pneumatic pressure driven primer pump [38]. In one embodiment of the invention, the primer pump is [38] operatively associated with the hydraulic or pneumatic actuators [24] of the engine [30]. In an alternative embodiment of the invention, the starter system includes secondary hydraulic or pneumatic actuators [25] which are operatively associated with the primer pump [38] such that the secondary hydraulic or pneumatic actuators [25] actuate the primer pump actuator [39] and the alternator driver motor [44]. The primer pump [38] is actuated through a release valve [22], which releases hydraulic or pneumatic energy from an accumulator [25] to the hydraulic or pneumatic actuator [39], which actuator [39] in turn is mechanically linked to the primer pump [38] for supplying the primer pump [38] with mechanical energy. This enables the primer pump [38] to generate priming fuel pressure to the high pressure injector pump.

The starter system [34] also includes a timer sequence unit [40] which manages time delay between actuation of the alternator [36] and the ECM [12], fuel supply to the engine [30], and cranking of the engine [30] thus ensuring that sufficient electricity and fuel is supplied to the engine [30] before the engine is cranked.

It will be appreciated that other embodiments of the invention may be possible without departing from the spirit or scope of the invention as defined in the claims.

1. A starter system adapted to actuate an electronic engine control module (ECM) of an electronically controlled fuel-injection engine when the engine is started, wherein the engine comprises a fuel tank and a high pressure injector pump which are arranged in flow communication with a series of injector nozzles; the starter system comprising an alternator which is operatively associated with the ECM for actuating the ECM, the arrangement being such that when the engine is started, the alternator supplies the ECM with electrical current before the engine is cranked.

2. The starter system according to claim 1, wherein the alternator is a hydraulic or pneumatic pressure driven alternator.

3. The starter system according to claim 2, wherein the alternator is operatively associated with hydraulic or pneumatic actuators of the engine.

4. The starter system according to claim 2, wherein the starter system includes secondary hydraulic or pneumatic actuators which are operatively associated with the alternator such that the secondary hydraulic or pneumatic actuators actuate only the alternator.

5. The starter system according to claim 2, wherein the alternator is actuated through a release valve, which releases hydraulic or pneumatic energy from an accumulator to a hydraulic or pneumatic pressure driven alternator driver motor, which driver motor in turn is mechanically linked to the alternator for supplying the alternator with mechanical energy, thus enabling the alternator to generate electrical current supply to the ECM for actuating the ECM.

6. The starter system according to claim 1, wherein the ECM alternator is disconnected from the engine such that the ECM alternator is actuated first and before the engine starts running.

7. The starter system according to claim 1, wherein the starter system includes a secondary low pressure primer pump which is arranged in flow communication with the fuel tank and the injector pump, the primer pump being adapted to maintain a positive fuel pressure at the injector pump at commencement of an engine starting process, thus enabling substantially immediate starting of the engine.

8. The starter system according to claim 7, wherein the primer pump is positioned intermediate the fuel tank and the injector pump such that fuel from the fuel tank passes through the primer pump before proceeding to the injector pump, the arrangement being such that a constant fuel pressure is maintained at the injector pump.

9. The starter system according to claim 5, wherein the primer pump is mechanically linked to the alternator driver motor such that when the alternator driver motor is actuated by the hydraulic or pneumatic pressure, the driver motor not only actuates the alternator, but also actuates the primer pump, such that the primer pump draws fuel from the fuel tank and provides priming pressure to the injector pump either before the engine cranked, or simultaneously while the engine is being cranked.

10. The starter system according to claim 5, wherein the primer pump is operatively associated with a second, independent actuator which is actuated by hydraulic or pneumatic pressure, the arrangement being such that upon actuation of the primer pump, the primer pump draws fuel from the fuel tank and provides priming pressure to the injector pump either before the engine is cranked, or simultaneously while the engine is being cranked.

11. The starter system according to claim 7, wherein the primer pump is a hydraulic or pneumatic pressure actuated primer pump.

12. The starter system according to claim 11, wherein the primer pump is operatively associated with hydraulic or pneumatic actuators of the engine.

13. The starter system according to claim 11, wherein the starter system includes secondary hydraulic or pneumatic actuators which are operatively associated with the primer pump such that the secondary hydraulic or pneumatic actuators actuate the primer pump and an alternator driver motor.

14. The starter system according to claim 5, wherein the primer pump is actuated through a release valve, which releases hydraulic or pneumatic energy from an accumulator to the hydraulic or pneumatic pressure driven alternator driver motor, which driver motor in turn is mechanically linked to the primer pump for supplying the primer pump with mechanical energy, thus enabling the primer pump to supply priming fuel pressure to the injector pump.

15. The starter system according to claim 1, wherein the starter system includes a timer sequence unit which manages time delay between actuation of the alternator and ECM, fuel supply to the engine and cranking of the engine, thus ensuring that sufficient electricity and fuel is supplied to the engine, either before the engine is cranked or while the engine is being cranked.

16. The starter system according to claim 15, wherein the timer sequence unit is operatively associated with the hydraulic or pneumatic actuators of the engine, the alternator and an engine starter motor.

17. The starter system according to claim 1, wherein the starter system is particularly suitable for use on electronically controlled fuel-injection diesel engines used in trackless mining machinery.

18. An electronically controlled fuel-injection engine comprising an ECM and a starter system for actuating the ECM, the starter system comprising an alternator which is operatively associated with the ECM for actuating the ECM such that when the engine started, the alternator supplies the ECM with electrical current either before the engine is cranked, or while the engine is being cranked.

19. The electronically controlled fuel-injection engine according to claim 18, wherein the alternator is a hydraulic or pneumatic pressure driven alternator.

20. An electronically controlled fuel-injection engine comprising an ECM and a starter system according to claim 1.

21. A method of actuating an ECM of an electronically controlled fuel-injection engine, the method comprising the use of an alternator which is operatively associated with the ECM for actuating the ECM such that when the engine is started, the alternator supplies the ECM with electrical current before the engine is cranked or while the engine is being cranked.

22. The method according to claim 21, wherein the alternator is a hydraulic or pneumatic pressure driven alternator.

23. The method according to claim 22, including the additional steps of providing hydraulic or pneumatic actuators which are positioned such that they actuate only the alternator and which include a release valve; and a hydraulic or pneumatic pressure driven alternator driver motor which is operatively associated with the hydraulic or pneumatic actuators and with the alternator; the arrangement being such that by releasing the release valve, hydraulic or pneumatic energy is released to the alternator driver motor, which in turn supplies the alternator with energy such that the alternator generates electrical current supply to the ECM for actuating the ECM.

24. The method according to claim 22, including the additional steps of providing hydraulic or pneumatic actuators which are positioned such that they actuate both the alternator and the primer pump, either simultaneously or sequentially, the arrangement being such that the primer pump is selectively disengaged once a common rail system can sustain its own low pressure fuel supply.

25. The starter system according to claim 1, substantially as illustrated and exemplified with reference to the accompanying drawings.

26. The electronically controlled fuel-injection engine according to claim 18, substantially as illustrated and exemplified with reference to the accompanying drawings.

27. The method of actuating an ECM of an electronically controlled fuel-injection engine according to claim 21, substantially as illustrated and exemplified with reference to the accompanying drawings.
